(19) United States
(12) Patent Application Publication
(10) Pub. No.: US 2017/0057108 A1
(43) Pub. Date: Mar. 2, 2017

(54) Multi-Functional Holster for Children's Scissors

(71) Applicant: Acme United Corporation, Fairfield, CT (US)

(72) Inventors: Sarah A. Albano, Fairfield, CT (US); Siu-Leung Tang, Hong Kong (CN)

(21) Appl. No.: 15/244,494

(22) Filed: Aug. 23, 2016

Related U.S. Application Data
(60) Provisional application No. 62/211,940, filed on Aug. 31, 2015.

(51) Int. Cl. B26B 29/04; B43L 23/06; B26B 13/12

(52) U.S. Cl. CPC B26B 29/04; B26B 13/12; B43L 23/06

(57) ABSTRACT

A multi-functional holster is especially adapted for receiving a pair of child's scissors. The holster is preferably in the form of a rigid or semi-rigid housing having a front and a flange-like periphery defining a scissor opening. A chute is mounted to said housing for receiving the blades of a pair of scissors inserted into the scissor opening. A pencil sharpener is mounted to the housing and interiorly disposed to be accessible through an access opening through the flange-like periphery. The scissors are retained in said housing by at least one magnet and at least one retention tab. The front of the housing may be generally shaped in the form of an apple or a whale and be suitably decorated to appeal to a child.

### BACKGROUND

This disclosure relates generally to children's scissors, such as, for example, are used at school. More particularly, this disclosure relates to integrating multiple useful children's articles into a single assembly.

### SUMMARY

Briefly stated, a multi-functional holder comprises a housing having a front and a flange-like periphery. The periphery has a top defining a scissor opening and opposed sides with one side defining an access opening. The housing defines an interior. A pencil sharpener is mounted to the housing and interiorly disposed to be accessible through the access opening. A chute for receives the blades of a pair of scissors inserted into the scissor opening. At least one magnet is positioned adjacent the chute for magnetically bonding with a scissor blade.

The pencil sharpener is generally disposed at an angle to the chute. The chute defines a central axis and two magnets are axially spaced along the chute. The front is substantially planar and, in one embodiment, has the general shape of an apple or a whale. The housing has an underside at least partially defining the interior and the chute is mounted at the underside. The housing has a generally circumferential flange disposed orthogonal to the front.

A pair of scissors is received in the chute and attracted in a fixed position by at least one magnet. The scissors preferably comprises a pair of substantially D-shaped handles.

A multi-functional holster for a pair of child's scissors comprises a rigid housing having a front. A generally circumferential flange extends orthogonally from the front and defines a scissor opening and an access opening. A pencil sharpener is mounted to the housing and interiorly disposed to be accessible through the access opening. A chute is configured to receive the blades of the scissors upon insertion of the scissors through the scissor opening. A magnet is positioned adjacent the chute and magnetically bondable with a scissor blade.

The pencil sharpener is generally disposed at an angle relative to the chute. The chute defines a central axis and two magnets are axially spaced along the chute. The front is substantially planar and has a general shape of an apple or a whale. At least one retention tab projects to engage a pair of scissors upon reception in the chute.

A multi-functional holster and a pair of child's scissors comprises a pair of child's scissors with a pair of handles and a pair of metal blades. A rigid housing has a front and a flange extending generally peripherally and orthogonally from the front. The flange defines a scissor opening and an access opening. A pencil sharpener is mounted to the housing and interiorly disposed to be accessible through the access opening. A chute receives the blades of the scissors so that the handle extends outwardly beyond the scissor opening. A magnet is positioned adjacent the chute and magnetically bonded with a scissor blade.

The pencil sharpener is generally disposed at an angle relative to the chute. The chute defines a central axis and two magnets are axially spaced along the chute. The front is substantially planar and the general shape of an apple or a whale. At least one retention tab projects to engage the pair of scissors.

### BRIEF DESCRIPTION OF THE ILLUSTRATIONS

FIG. 1 is an illustration of a multi-functional holster with a pair of received scissors;

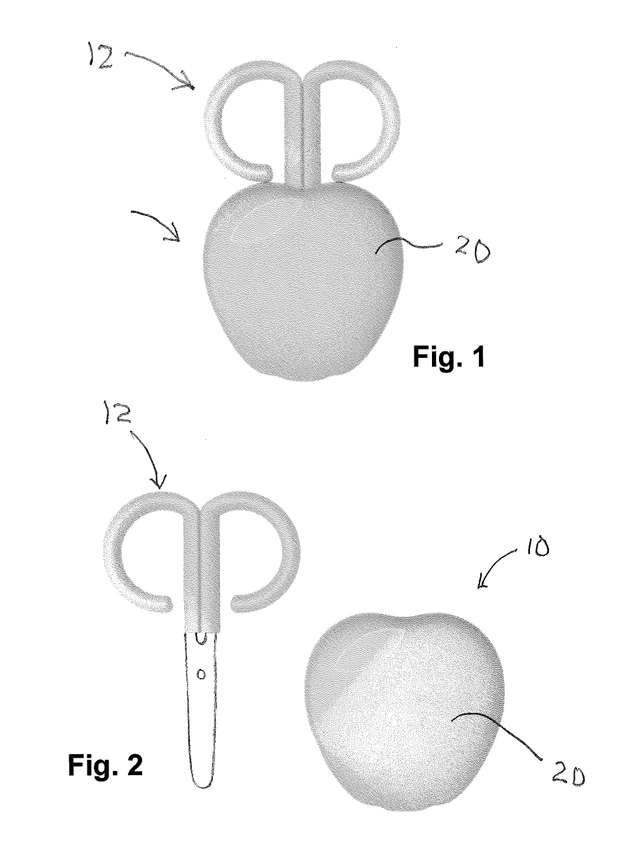

FIG. 2 is a frontal illustration of the holster and scissors of FIG. 1 with the scissors removed;

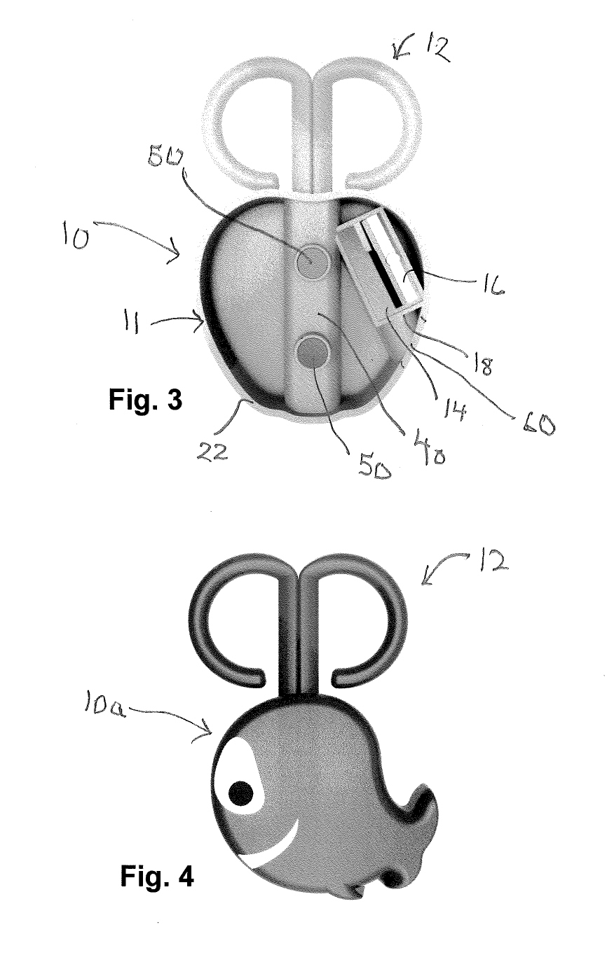

FIG. 3 is an illustration of the rear view of the holster and scissors of FIG. 1;

FIG. 4 is a frontal illustration of a second embodiment of a multi-functional holster with received scissors;

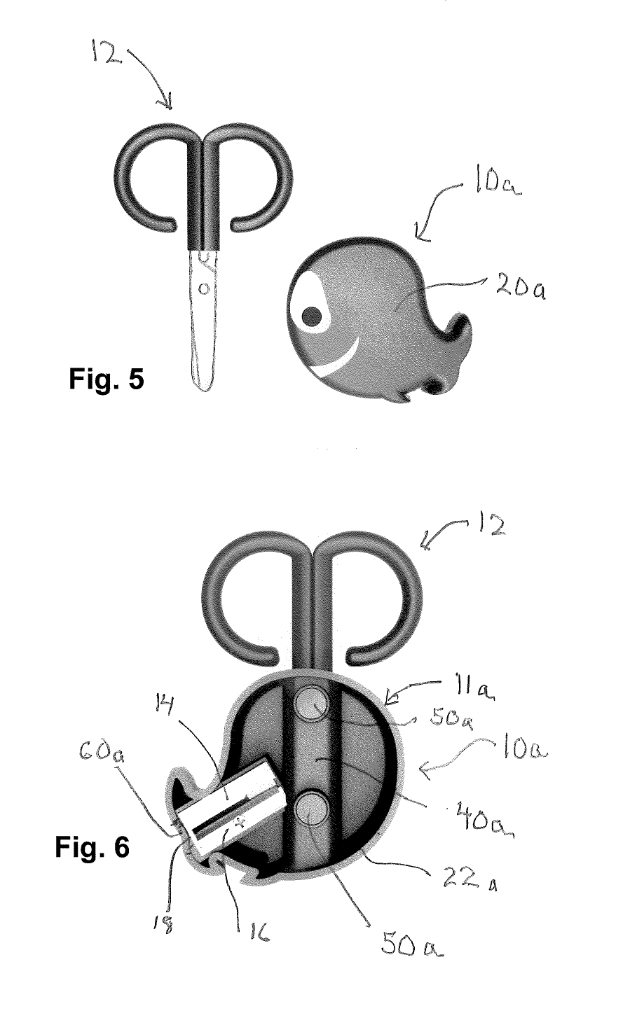

FIG. 5 is a frontal illustration of the holster and scissors of FIG. 4 of with the scissors removed from the holster;

FIG. 6 is a rear illustration of the holster and received scissors of FIG. 4;

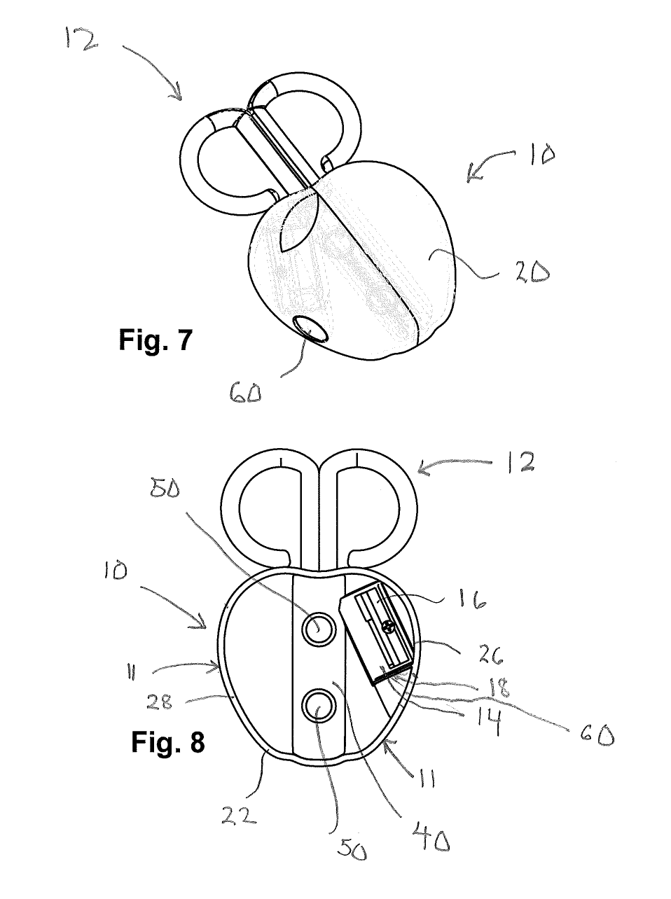

FIG. 7 is a frontal perspective view of the holster and received scissors of FIG. 1;

FIG. 8 is a rear view of the holster and received scissors of FIG. 1;

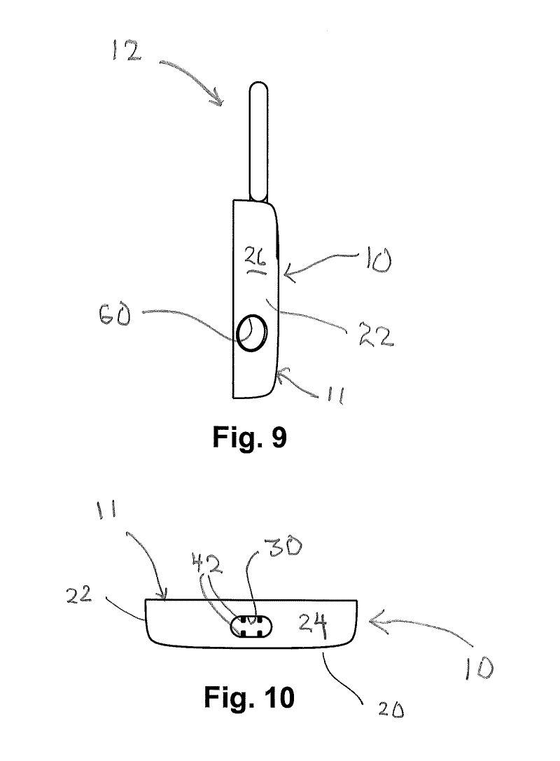

FIG. 9 is a right side view of the holster and received scissors of FIG. 1;

FIG. 10 is a top plan view of the holster of FIG. 2 with the scissors removed;

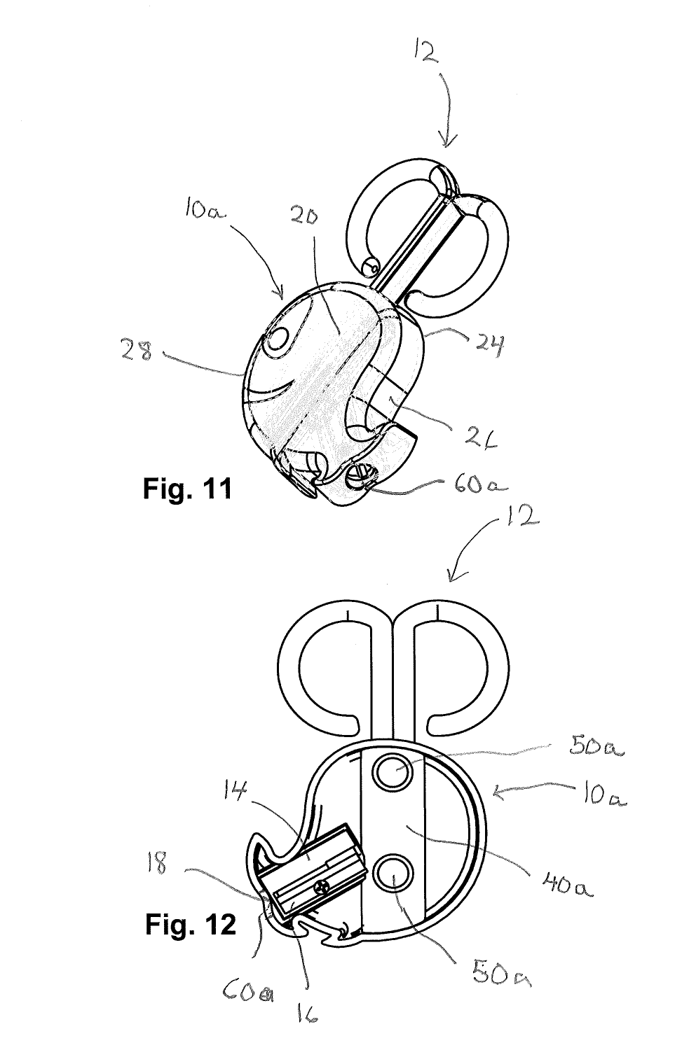

FIG. 11 is a perspective view of the holster and received scissors of FIG. 4;

FIG. 12 is a rear view of the holster and received scissors of FIG. 4;

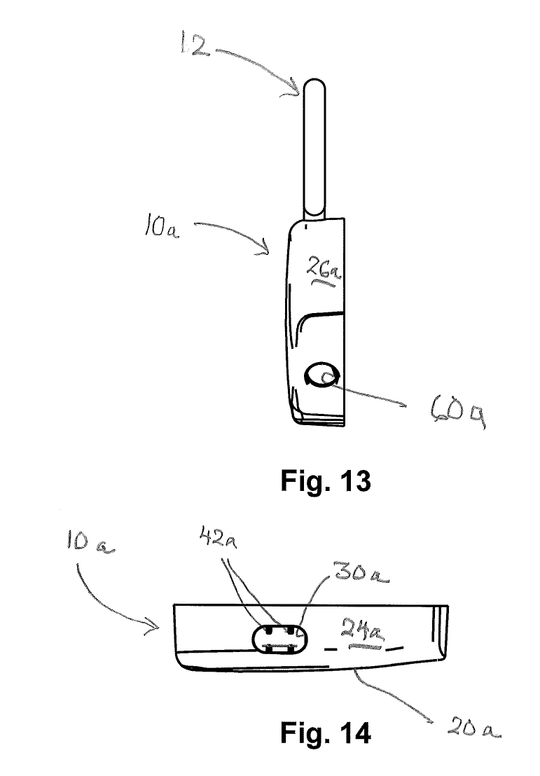

FIG. 13 is a left side view of the holster and received scissors of FIG. 4; and

FIG. 14 is a top plan view of the holster of FIG. 5 with the scissors removed.

### DETAILED DESCRIPTION

With reference to the illustrations wherein like numerals represent like parts throughout the several views, a multi-functional holster is generally designated by the numeral 10 in FIGS. 1-3 and 7-10, and by the numeral 10a in FIGS. 4-6 and 11-14. The multi-functional holster 10, 10a functions to receive the cutting blades of a child's scissors 12 to provide a protective safety cover therefor. The multi-functional holster also mounts a mechanical pencil sharpener 14 having a blade 16 and an access opening 18. The holster thus functions to integrate the protective coverage for the scissors as well as to provide a convenient mounting structure for the pencil sharpener 14.

It will be appreciated that the front and side portions of the holster 10 have the shape of fanciful objects or animals which are appealing to children, such as an apple for the holster 10 and a whale for the holster 10a. Other suitable fanciful shapes may also be employed. The holster is manufactured from plastic and suitably tinted and decorated.

The child's scissors 12 may assume a number of forms, but the holsters 10, 10a have particular applicability in connection with scissors 12 which are substantially formed from metal components 13 which are pivotally joined and form a substantially quasi-D-shaped handles 15. The handles may have a plastic, polyurethane or other soft overlay material to facilitate usage by the child. The blades are typically blunted for safety purposes. The holsters 10a are also suitable for use within the scissor configurations.

The holster 10 comprises a shell-like housing 11 having a generally frontal face 20 which may be planar. The face preferably has a fanciful shape appealing to children. A flange-like edge 22 rearwardly extends from the face and preferably has a uniform width and irregular shape defined by the frontal face 20. For purposes of description, the flange 22, which is substantially continuous, has an upper portion 24 at the top and a pair of side portions 26 and 28.

A scissor opening 30 is defined in the top portion 24 to provide an entry opening for the blades of the scissors. A chute 40 is formed at the rear and may be integrally formed to provide a passage communicating with opening 30 for receiving the blades. In one preferred form, the chute 40 has a generally uniform shape extending from the top portion to the bottom portion of the holster 10 and defines a central (vertical) axis. Both the scissor opening 30 and the passage of the chute 40 preferably have an oval shape to accommodate the scissor blades.

The chute 40 is also dimensioned to somewhat closely receive the blades of the scissors. One or more magnets 50 are embedded in the chute. The magnets are axially spaced. When the scissors 12 are inserted into the chute 40, the scissors are temporarily maintained in the holster by the magnets 50, as well as the cooperative sides of the chute. In some embodiments, the chute may have an opened or interrupted construction rather than the illustrated solid construction. Retention tabs 42 (FIG. 10) may also extend integrally into the chute for retaining the scissors.

The pencil sharpener 14 is typically mounted at an angle to the axis of the chute. An access opening 60 is formed through a flange portion of the holster to provide access to the access opening 18 of the pencil sharpener.

Corresponding components for holster 10a are designated by the same numerals for holster 10 followed by the letter a.

It will thus be appreciated that each holster 10, 10a functions to provide an efficient and effective covering for the blades of children's scissors 12 as well as a convenient mounting structure so that the mechanical sharpener 14 is also readily available for easy access and usage.

While preferred embodiments of the foregoing holsters and scissors have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A multi-functional holster comprising:
a housing having a front and a flange-like periphery having a top defining a scissor opening and opposed sides with one said side defining an access opening, said housing defining an interior;
a pencil sharpener mounted to said housing and interiorly disposed to be accessible through said access opening;
a chute for receiving the blades of a pair of scissors inserted into said scissor opening; and
at least one magnet positioned adjacent said chute for magnetically bonding with a scissor blade.

2. The multi-functional holster of claim 1 wherein the pencil sharpener is generally disposed at an angle to said chute.

3. The multi-functional holster of claim 1 wherein said chute defines a central axis and two magnets are axially spaced along the chute.

4. The multi-functional holster of claim 1 wherein said front is substantially planar and has the general shape of an apple or a whale.

5. The multi-functional holster of claim 1 wherein said housing has an underside at least partially defining the interior and said chute is mounted at said underside.

6. The multi-functional holster of claim 1 wherein said housing has a generally circumferential flange disposed orthogonally to said front.

7. The multi-functional holster of claim 6 wherein said flange has a substantially uniform depth.

8. The multi-functional holster of claim 1 further comprising at least one retention tab projecting interiorly into said chute for retaining a blade.

9. The multi-functional holster of claim 1 further comprising a pair of scissors received in said chute and attracted in a fixed position by at least one magnet.

10. The multi-functional holster and scissors of claim 9 wherein said scissors comprise a pair of substantially D-shaped handles.

11. A multi-functional holster for a pair of child's scissors comprising:
a rigid housing having a front and a generally circumferential flange extending orthogonally from said front and defining a scissor opening and an access opening, said housing defining an interior;
a pencil sharpener mounted to said housing and interiorly disposed to be accessible through said access opening; and
a chute configured to receive the blades of said scissors upon insertion through said scissor opening.

12. The multi-functional holster of claim 11 wherein the pencil sharpener is generally disposed at an angle relative to said chute.

13. The multi-functional holster of claim 11 wherein said chute defines a central axis and two magnets are axially spaced along the chute.

14. The multi-functional holster of claim 11 wherein said front is substantially planar and has the general shape of an apple or a whale.

15. The multi-functional holster of claim 11 further comprising at least one retention tab projecting to engage a pair of scissors upon reception in said chute.

16. A multi-functional holster and a pair of child's scissors comprising:
a pair of child's scissors comprising a pair of handles and a pair of metal blades;
a substantially rigid housing having a front and a flange extending generally peripherally and orthogonally from said front and defining a scissor opening and an access opening, said housing defining an interior;
a pencil sharpener mounted to said housing and interiorly disposed to be accessible through said access opening;
a chute receiving the blades of said scissors so that said handles extend outwardly beyond said scissor opening; and
a magnet positioned adjacent said chute and magnetically bonded with a scissor blade.

17. The multi-functional holster of claim 16 wherein the pencil sharpener is generally disposed at an angle relative to said chute.

18. The multi-functional holster of claim 16 wherein said chute defines a central axis and two magnets are axially spaced along the chute.

19. The multi-functional holster of claim 16 wherein said front is substantially planar and has the general shape of an apple or a whale.

20. The multi-functional holster of claim 16 wherein said scissor opening has an oval shape.
